(19) United States
(12) Patent Application Publication
(10) Pub. No.: US 2024/0330877 A1
(43) Pub. Date: Oct. 3, 2024

(54) TRANSFER OF LIQUID STAKING TOKENS

(71) Applicant: Coinbase, Inc., Oakland, CA (US)

(72) Inventors: John Zettler, San Francisco, CA (US); Ahsan Chudhary, Milpitas, CA (US); Ruixin Li, Redmond, WA (US); Rhea Kaw, Bellevue, WA (US); David Knott, San Francisco, CA (US); Nishant Gupta, Oakland, CA (US)

(21) Appl. No.: 18/129,572

(22) Filed: Mar. 31, 2023

(51) Int. Cl. G06Q 20/10; G06Q 20/36; G06Q 20/38; G06Q 20/42

(52) U.S. Cl. CPC G06Q 20/10; G06Q 20/3672; G06Q 20/3678; G06Q 20/381; G06Q 20/389; G06Q 20/42

(57) ABSTRACT

Methods, systems, and devices for data management are described. A custodial token platform implements a preminting process to facilitate wrapping staked crypto tokens and enables unwrapping the wrapped crypto tokens for liquid staking crypto tokens. The platform receives a first request to wrap a first amount of a first crypto token that is staked. The platform associates a second amount of the second crypto token with the first user profile, where the second crypto token is transferrable and minted, and based on a first value of a current conversion ratio between the first crypto token and the second crypto token. The platform receives, from a first or second user profile, a second request to unwrap the second crypto token, which is based on a second value of the current conversion ratio between the first crypto token and the second crypto token.

### FIELD OF TECHNOLOGY

The present disclosure relates generally to token management, including techniques for transferring liquid staking tokens.

### BACKGROUND

Blockchains and related technologies may be employed to support recordation of ownership of digital assets, such as cryptocurrencies, fungible tokens, non-fungible tokens (NFTs), and the like. Generally, peer-to-peer networks support transaction validation and recordation of transfer of such digital assets on blockchains. Various types of consensus mechanisms may be implemented by the peer-to-peer networks to confirm transactions and to add blocks of transactions to the blockchain networks. Example consensus mechanisms include the proof-of-work consensus mechanism implemented by the Bitcoin network and the proof-of-stake mechanism implemented by the Ethereum network. Some nodes of a blockchain network may be associated with a digital asset exchange, which may be accessed by users to trade digital assets or trade a fiat currency for a digital asset.

### BRIEF DESCRIPTION OF THE DRAWINGS

FIG. 1 illustrates an example of a computing environment that supports transferring of liquid staking tokens in accordance with aspects of the present disclosure.

FIG. 2 illustrates another example of a computing environment that supports transferring of liquid staking tokens in accordance with aspects of the present disclosure.

FIG. 3 illustrates an example of a user interface of an application that supports transferring of liquid staking tokens in accordance with aspects of the present disclosure.

FIG. 4 illustrates an example of a process flow that supports transferring of liquid staking tokens in accordance with aspects of the present disclosure.

FIG. 5 illustrates a block diagram of an apparatus that supports transferring of liquid staking tokens in accordance with aspects of the present disclosure.

FIG. 6 illustrates a block diagram of a token manager that supports transferring of liquid staking tokens in accordance with aspects of the present disclosure.

FIG. 7 illustrates a diagram of a system including a device that supports transferring of liquid staking tokens in accordance with aspects of the present disclosure.

FIGS. 8 through 11 illustrate flowcharts showing methods that support transferring of liquid staking tokens in accordance with aspects of the present disclosure.

### DETAILED DESCRIPTION

A user may access a custodial token platform to purchase, sell, exchange, or trade digital assets, such as cryptocurrencies, crypto tokens, or the like. A custodial token platform may support various types of wallets for deposits, withdrawals, and storage. For example, the custodial token platform may generate inbound wallets associated with inbound addresses for user deposits of crypto tokens to accounts associated with the user. The custodial token platform may also use outbound wallets for supporting withdrawals of crypto tokens and cold storage wallets for security. In some cases, the custodial token platform may support a wallet orchestration procedure that moves the crypto tokens between the various wallets of the custodial token platform for various reasons including liquidity management and security. In some examples, users may stake crypto tokens via the custodial token platform. Staking refers to the process by which the user may lock a crypto token for the network, allowing the user to participate in consensus, validating transactions, and to create blocks, in order to facilitate securing the network. In return, the user staking the crypto token (e.g., staking user) earns rewards, such as interest on the amount of crypto tokens staked. In some cases, the rewards may be the result of new issuance or net-new issuance of tokens by a blockchain protocol.

When the user stakes a crypto token via a blockchain network, the crypto token may become locked, which makes the crypto token non-transferable. As such, the user may be unable to sell, exchange, or otherwise trade the staked crypto token on the custodial token platform or transact with the crypto token via the blockchain network. In some cases, the staked crypto token may not be “unstaked” or reverted to the transferrable crypto token for a lockup period. These limitations may result in the unwillingness of a user holding crypto tokens to stake, possibly resulting in reduced network security.

Techniques described herein address the forgoing by supporting wrapping locked staked crypto tokens into transferrable crypto tokens. The wrapped staked crypto token may represent the underlying staked crypto token, as well as rewards earned for staking the crypto token. The wrapped staked crypto token may be fully transferrable via the blockchain network. Additionally, the wrapped staked token may be unwrapped to access the underlying staked crypto token. The technique of wrapping the staked crypto token may result in increased liquidity for the staked crypto tokens, as well as provide an incentive to continue staking crypto tokens to earn rewards while increasing network security.

In some examples, the custodial token platform may receive a request to wrap a staked crypto token from a user. The staked crypto token of the user may be non-transferrable. The custodial token platform may associate a wrapped crypto token, which represents the staked crypto token, with a wallet address or account of the user. The wrapped crypto token is transferrable so that the user may sell, exchange, and the like, within the custodial token platform or via the blockchain network external to the custodial token platform. The wrapped crypto token may be minted by a self-executing program deployed to the blockchain network. The value of the wrapped crypto token may be based on a first value of a current conversion ratio between the staked crypto token and the wrapped staked crypto token. The user or a second user may request to unwrap the wrapped crypto token to the staked crypto token. The custodial token platform may associate the unwrapped token to the requesting user address or user account. The value of the unwrapped staked token is based on a second value of a current conversion ratio between the staked crypto token and the wrapped crypto token. Accordingly, the conversion ratio may be dynamic and may be based on a difference between the rewards received for the staked crypto tokens and penalties or fees. In some cases, the slashing penalties may be instilled by the network and may be associated with network downtime or erroneous data submissions. These and other techniques are described in further detail with respect to the figures.

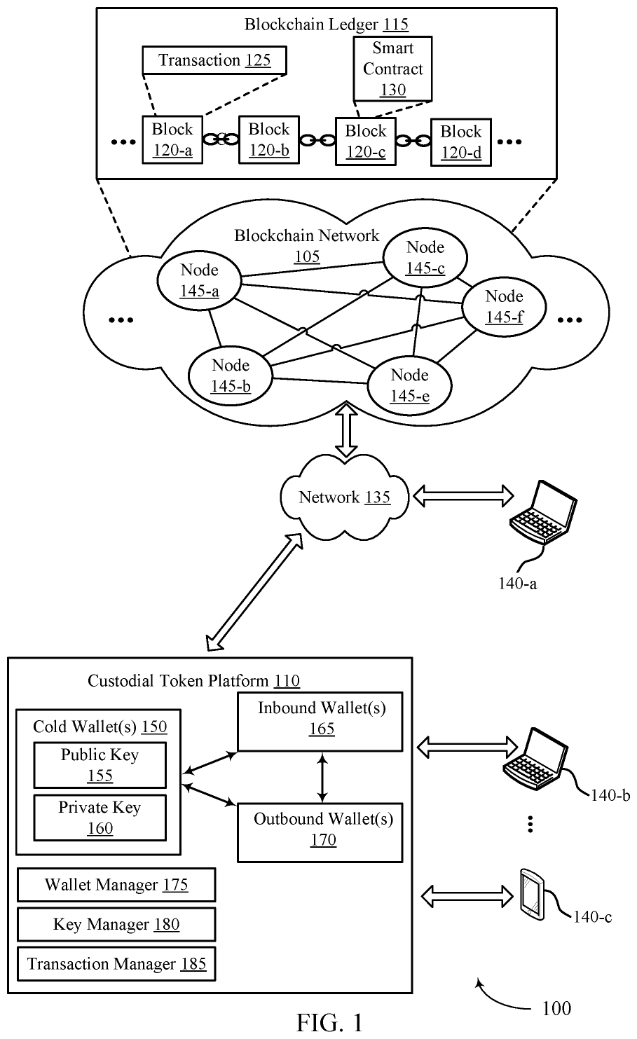

FIG. 1 illustrates an example of a computing environment 100 that supports exchange of liquid staking tokens in accordance with aspects of the present disclosure. The computing environment 100 may include a blockchain network 105 that supports a blockchain ledger 115, a custodial token platform 110, and one or more computing devices 140, which may be in communication with one another via a network 135.

The network 135 may allow the one or more computing devices 140, one or more nodes 145 of the blockchain network 105, and the custodial token platform 110 to communicate (e.g., exchange information) with one another. The network 135 may include aspects of one or more wired networks (e.g., the Internet), one or more wireless networks (e.g., cellular networks), or any combination thereof. The network 135 may include aspects of one or more public networks or private networks, as well as secured or unsecured networks, or any combination thereof. The network 135 also may include any quantity of communications links and any quantity of hubs, bridges, routers, switches, ports or other physical or logical network components.

Nodes 145 of the blockchain network 105 may generate, store, process, verify, or otherwise use data of the blockchain ledger 115. The nodes 145 of the blockchain network 105 may represent or be examples of computing systems or devices that implement or execute a blockchain application or program for peer-to-peer transaction and program execution. For example, the nodes 145 of the blockchain network 105 support recording of ownership of digital assets, such as cryptocurrencies, fungible tokens, non-fungible tokens (NFTs), and the like, and changes in ownership of the digital assets. The digital assets may be referred to as tokens, coins, crypto tokens, or the like. The nodes 145 may implement one or more types of consensus mechanisms to confirm transactions and to add blocks (e.g., blocks 120-a, 120-b, 120-c, and so forth) of transactions (or other data) to the blockchain ledger 115. Example consensus mechanisms include a proof-of-work consensus mechanism implemented by the Bitcoin network and a proof-of-stake consensus mechanism implemented by the Ethereum network.

When a device (e.g., the computing device 140-a, 140-b, or 140-c) associated with the blockchain network 105 executes or completes a transaction associated with a token supported by the blockchain ledger, the nodes 145 of the blockchain network 105 may execute a transfer instruction that broadcasts the transaction (e.g., data associated with the transaction) to the other nodes 145 of the blockchain network 105, which may execute the blockchain application to verify the transaction and add the transaction to a new block (e.g., the block 120-d) of a blockchain ledger (e.g., the blockchain ledger 115) of transactions after verification of the transaction. Using the implemented consensus mechanism, each node 145-c may function to support maintaining an accurate blockchain ledger 115 and prevent fraudulent transactions.

The blockchain ledger 115 may include a record of each transaction (e.g., a transaction 125) between wallets (e.g., wallet addresses) associated with the blockchain network 105. Some blockchains may support smart contracts, such as smart contract 130, which may be an example of a sub-program that may be deployed to the blockchain and executed when one or more conditions defined in the smart contract 130 are satisfied. For example, the nodes 145 of the blockchain network 105 may execute one or more instructions of the smart contract 130 after a method or instruction defined in the smart contract 130 is called by another device. In some examples, the blockchain ledger 115 is referred to as a blockchain distributed data store.

A computing device 140 may be used to input information to or receive information from the computing system custodial token platform 110, the blockchain network 105, or both. For example, a user of the computing device 140 a may provide user inputs via the computing device 145-a, which may result in commands, data, or any combination thereof being communicated via the network 135 to the computing system custodial token platform 110, the blockchain network 105, or both. Additionally, or alternatively, a computing device 140-a may output (e.g., display) data or other information received from the custodial token platform 110, the blockchain network 105, or both. A user of a computing device 140-a may, for example, use the computing device 140 a to interact with one or more user interfaces (e.g., graphical user interfaces (GUIs)) to operate or otherwise interact with the custodial token platform 110, the blockchain network 105, or both.

A computing device 140 or a node 145 may be a stationary device (e.g., a desktop computer or access point) or a mobile device (e.g., a laptop computer, tablet computer, or cellular phone). In some examples, a computing device 140 or a node 145 may be a commercial computing device, such as a server or collection of servers. And in some examples, a computing device 140 or a node 145 may be a virtual device (e.g., a virtual machine).

Some blockchain protocols support layer one and layer two crypto tokens. A layer one token is a token that is supported by its own blockchain protocol, meaning that the layer one token (or a derivative thereof), may be used to pay transaction fees for transacting using the blockchain protocol. A layer two token is a token that is built on top of layer one, for example, using a smart contract 130 or a decentralized application (“Dapp”). The smart contract 130 or decentralized application may issue layer two tokens to various users based on various conditions, and the users may transact using the layer two tokens, but transaction fees may be based on the layer one token (or a derivative thereof).

The custodial token platform 110 may support exchange or trading of digital assets, fiat currencies, or both by users of the custodial token platform 110. The custodial token platform 110 may be accessed via website, web application, or applications that are installed on the one or more computing devices 140. The custodial token platform 110 may be configured to interact with one or more types of blockchain networks, such as the blockchain network 105, to support digital asset purchase, exchange, deposit, and withdrawal.

For example, users may create accounts associated with the custodial token platform 110 such as to support purchasing of a digital asset via a fiat currency, selling of a digital asset via fiat currency, or exchanging or trading of digital assets. A key management service (e.g., a key manager) of the custodial token platform 110 may create, manage, or otherwise use private keys that are associated with user wallets and internal wallets. For example, if a user wishes to withdraw a token associated with the user account to an external wallet address, key manager 180 may sign a transaction associated with a wallet of the user, and broadcast the signed transaction to nodes 145 of the blockchain network 105, as described herein. In some examples, a user does not have direct access to a private key associated with a wallet or account supported or managed by the custodial token platform 110. As such, user wallets of the custodial token platform 110 may be referred to non-custodial wallets or non-custodial addresses.

The custodial token platform 110 may create, manage, delete, or otherwise use various types of wallets to support digital asset exchange. For example, the custodial token platform 110 may maintain one or more internal cold wallets 150. The internal cold wallets 150 may be an example of an offline wallet, meaning that the cold wallet 150 is not directly coupled with other computing systems or the network 135 (e.g., at all times). The cold wallet 150 may be used by the custodial token platform 110 to ensure that the custodial token platform 110 is secure from losing assets via hacks or other types of unauthorized access and to ensure that the custodial token platform 110 has enough assets to cover any potential liabilities. The one or more cold wallets 150, as well as other wallets of the blockchain network 105 may be implemented using public key cryptography, such that the cold wallet 150 is associated with a public key 155 and a private key 160. The public key 155 may be used to publicly transact via the cold wallet 150, meaning that another wallet may enter the public key 155 into a transaction such as to move assets from the wallet to the cold wallet 150. The private key 160 may be used to verify (e.g., digitally sign) transactions that are transmitted from the cold wallet 150, and the digital signature may be used by nodes 145 to verify or authenticate the transaction. Other wallets of the custodial token platform 110 or the blockchain network 105 may similarly use aspects of public key cryptography.

The custodial token platform 110 may also create, manage, delete, or otherwise use inbound wallets 165 and outbound wallets 170. For example, a wallet manager 175 of the custodial token platform 110 may create a new inbound wallet 165 for each user or account of the custodial token platform 110 or for each inbound transaction (e.g., deposit transaction) for the custodial token platform 110. In some examples, the custodial token platform 110 may implement techniques to move digital asset between wallets of the digital asset exchange platform. Assets may be moved based on a schedule, based on asset thresholds, liquidity requirements, or a combination thereof. In some examples, movements or exchanges of assets internally to the custodial token platform 110 may be “off-chain” meaning that the transactions associated with the movement of the digital asset are not broadcast via the corresponding blockchain network (e.g., blockchain network 105). In such cases, the custodial token platform 110 may maintain an internal accounting (e.g., ledger) of assets that are associated with the various wallets or user accounts.

As used herein, a wallet, such as inbound wallets 165 and outbound wallets 170 may be associated with a wallet address, which may be an example of a public key, as described herein. The wallets may be associated with a private key that is used to sign transactions and messages associated with the wallet. A wallet may also be associated with various user interface components and functionality. For example, some wallets may be associated with or leverage functionality for transmitting crypto tokens by allowing a user to enter a transaction amount, a receiver address, etc. into a user interface and clicking or activating a UI component such that the transaction is broadcast via the corresponding blockchain network via a node (e.g., a node 145) associated with the wallet. As used herein, “wallet” and “address” may be used interchangeably.

In some cases, the custodial token platform 110 may implement a transaction manager 185 that supports monitoring of one or more blockchains, such as the blockchain ledger 115, for incoming transactions associated with addresses managed by the custodial token platform 110 and creating and broadcasting on-blockchain transactions when a user or customer sends a digital asset (e.g., a withdrawal). For example, the transaction manager 185 may monitor the addressees of the customers for transfer of layer one or layer two tokens supported by the blockchain ledger 115 to the addresses managed by the custodial token platform 110. As another example, when a user is withdrawing a digital asset, such as a layer one or layer two token, to an external wallet (e.g., an address that is not managed by the custodial token platform 110 or an address for which the custodial token platform 110 does not have access to the associated private key), the transaction manager 185 may create and broadcast the transaction to one or more other nodes 145 of the blockchain network 105 in accordance with the blockchain application associated with the blockchain network 105. As such, the transaction manager 185, or an associated component of the custodial token platform 110 may function as a node 145 of the blockchain network 105.

As described herein, the custodial token platform may implement and support various wallets including the inbound wallets 165, the outbound wallets 170, and the cold wallets 150. Further, the custodial token platform 110 may implement techniques to maintain and manage balances of the various wallets. In some examples, the balances of the various wallets are configured to support security and liquidity. For example, the custodial token platform 110 may implement transactions that move crypto tokens between the inbound wallets 165 and the outbound wallets 170. These transactions may be referred to as “flush” transactions and may occur on a periodic or scheduled basis.

As described herein, various transactions may be broadcasted to the blockchain ledger 115 to cause transfer of crypto tokens, to call smart contracts 130, to deploy smart contracts etc. In some examples, these transactions may also be referred to as messages. That is, the custodial token platform 110 may broadcast a message to the blockchain network 105 to cause transfer of tokens between wallets managed by the custodial token platform 110 to cause transfer of tokens from a wallet managed by the custodial token platform 110 to an external wallet, to deploy a smart contract (e.g., a self-executing program), or to call a smart contract.

Additionally, a user may access a custodial token platform 110 to purchase, sell, exchange, or trade digital assets, such as cryptocurrencies, crypto tokens, or the like. In some examples, the custodial token platform 110 supports users staking crypto tokens (e.g., according to a proof-of-stake protocol). Staking is the process by which the user may lock a token for the network 135, allowing the user to participate in consensus, validate transactions, and create blocks, to facilitate securing the network 135. In return, the staking user earns rewards while the crypto token is locked. However, the user is unable to transfer or move the staked crypto token (e.g., during a lock period).

Techniques described herein address the forgoing by supporting a liquid staking mechanism that allows for a user to wrap locked staked crypto tokens, resulting in wrapped tokens that are transferrable. The wrapped staked crypto token may represent the underlying staked crypto token and associated rewards for the staked crypto token. The wrapped staked crypto token is transferrable and may be unwrapped to access the underlying staked crypto token. As such, the technique of wrapping and unwrapping the staked crypto token may result in increased liquidity for the staked crypto token, as well as provide an incentive to continue staking crypto tokens to earn rewards while also increasing network security.

As described herein, the term “staking” refers to the process by which a user may lock a crypto token for the network, allowing the user to participate in a consensus process for validating transactions and to create blocks in order to facilitate securing the network. In return, the user staking the crypto token (e.g., staking user) earns rewards, such as interest on the amount of crypto tokens staked. As described herein, the term “minting” refers to the process of generating or issuing new crypto tokens, such as by using a smart-contract. For example, a user may create a token contract that creates 1000 new tokens (e.g., each an Ethereum Request for Comment 20 (ERC-20) token). The process of creating the new tokens may be referred to minting, where 1000 tokens are minted, even if process may not involve any consensus mechanism of Ethereum nor a protocol's creation of new Ether. Newly minted crypto tokens are added to the circulation or the custodial token platform 110 to be traded. As described herein, the term “preminting” refers to a process to mint crypto tokens (e.g., existing liquidity, such as staked crypto tokens) to provide liquidity for wrapping. This preminting may be performed prior to a wrap request.

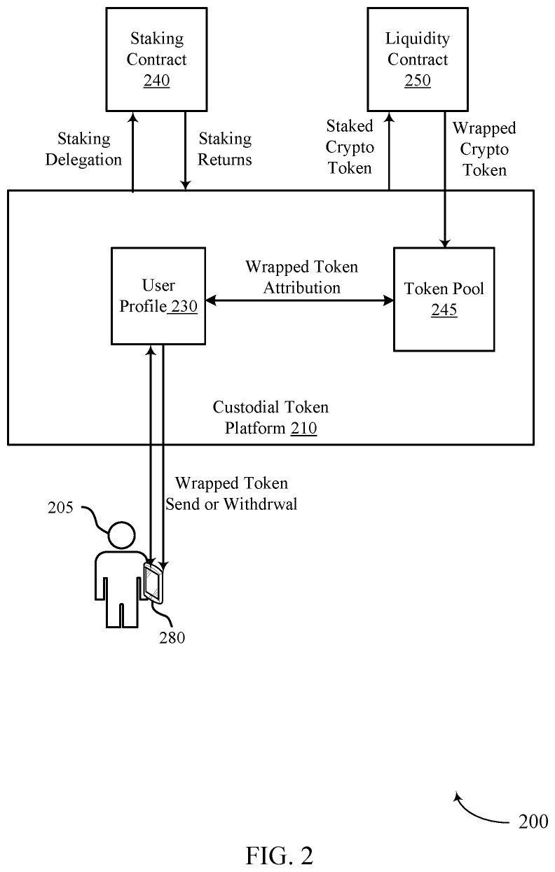

FIG. 2 illustrates another example of a computing environment 200 that supports transferring of liquid staking tokens in accordance with aspects of the present disclosure. The computing environment 200 includes a custodial token platform 210 and a user 205 with respective user device 280. The custodial token platform 210 may be an example of the custodial token platform 110 as described with respect to FIG. 1, and the user device 280 may be examples of the computing devices 140 as described with respect to FIG. 1. Although the discussions described herein relate to cryptocurrency with respect to crypto tokens, the cryptocurrency may include tokens, coins, digital currency, and the like.

The custodial token platform 210 may store or access token-related data, as well as support various token-related transactions for various purposes. For example, the custodial token platform 210 may support a user profile 230 and a token pool 245. The user profile 230 may include data associated with the user 205 with respect to the custodial token platform 210. The data may include one or more user addresses (e.g., wallet addresses), current cryptocurrencies held by the user 205 (e.g., Ether, Ether2, cbETH.), staked cryptocurrencies, rewards associated with the staked cryptocurrencies, past transactions, pending transactions, requests to wrap or unwrap staked crypto currencies, and the like. The user profile 230 may also provide or be associated with an interface that facilitates transfer of crypto tokens within the custodial token platform 210, such as an interface for requesting wrapping of staked crypto token associated with the user 205, as well as transfer of crypto tokens externally via the corresponding blockchain network. In some cases, a user may utilize the services described herein and request the wrapped token, which may result in sending a wrapped crypto token to the user profile 230. The user may then request to unwrap the wrapped crypto token, which may result in the token being returned too to the respective token pool (e.g., token pool 245).

For example, the custodial token platform may allow users to stake one or more types of crypto tokens according to a staking protocol associated with a respective blockchain network. Staking refers to a process in which users may delegate or contribute their crypto tokens to the blockchain network to support the blockchain network. Staking may involve locking crypto tokens for a set period of time to support the operation of the blockchain network. Users may be able to stake their crypto tokens from a non-custodial (e.g., self-custody) wallet, but the staking mechanism may be complex. As such, the custodial token platform 210 allows users to stake via the custodial token platform 210, which improves user experience while also contributing to the security of the blockchain network. In response to requesting to stake via the custodial token platform 210, the custodial token platform 210 may broadcast a message to a staking contract 240, as well as deposit crypto tokens into the staking contract 240. In some cases, the staking contract 240 is an example of a smart-contract that manages staking-related transactions. For example, the staking contract 240 may be a self-executing program stored on a blockchain that executes when conditions are met, such as a condition of receiving a staking request. The staking contract 240 may be used by the custodial token platform 210 to perform staking related procedures for users that stake via the custodial token platform 210. The staking contract 240 may execute and provide staking returns or rewards for the users staking via the custodial token platform 210. The custodial token platform 210 may maintain an internal accounting of those users that have staked via the custodial token platform 201, the amount of tokens staked by users, and the corresponding portion of rewards that should be associated with the users, and/or penalties associated with the user. An indication of the staking delegation, processes associated with the staking contract 240, or the amount of staking returns, may be indicated to the user 205 via the user interface of the custodial token platform 210.

As described herein, staking may involve locking an amount of the crypto token for a lockup period. However, the custodial token platform 210 may support a liquid staking procedure which awards a user with a liquidity token that represents a user's crypto tokens that are staked via the custodial token platform 210. The user 205 may trade via the custodial token platform 210 using the liquidity token or transact on the associated blockchain network via the liquidity token. Thus, the user 205 is effectively allowed to stake tokens and use an asset representing the staked token for other purposes. The liquidity token may be referred to as a “wrapped” token, as the token may be stored in a smart contract that rewards the user with the wrapped token. Additionally, techniques described herein allow for the user 205 that has received the wrapped token to “unwrap” the token and be rewarded with the underlying staked asset (which may be locked). When a user unwraps, the user (e.g., the user profile 230) may be given an amount of the staked asset that is based on the amount of rewards corresponding to the staked asset.

To support these techniques, the custodial token platform may deploy liquidity contract 250 to the blockchain network. The liquidity contract 250 may be used for minting the wrapped token that represents the staked token. Thus, when a user requests staking or requests the wrapped token representing their tokens staked via the custodial token platform 210, the custodial token platform 210 may transact with the liquidity contract 250 to mint new tokens representing the users staked tokens.

Additionally, to support the multitude of users accessing the custodial token platform 210, the custodial token platform 210 may implement a premint procedure to premint a pool of wrapped tokens and allow for instant liquidity for users of the custodial token platform 210. Thus, after deploying the liquidity contract 250, the custodial token platform 210 may premint a pool of wrapped tokens and store the wrapped tokens to the token pool 245. In some examples, a corresponding amount of locked, staked crypto tokens (e.g., staked ETH) may also be set aside and associated with any amount of pre-minted wrapped tokens. The token pool 245 may include a collection of crypto tokens (e.g., wrapped tokens and/or staked tokens in respective pools or combined pools). In some examples, the token pool 245 may provide crypto tokens, including wrapped crypto tokens, to the user 205 via the user devices 280 after a request for the wrapped crypto token, avoiding delay otherwise associated with the process of wrapping the user's staked crypto token and then sending the wrapped crypto token to the user 205. More particularly, the process of transacting with the liquidity contract 250 each time a user requests the wrapped token representing a staked asset may involve a significant amount of time. As such, the user may be given the wrapped token following the request, without waiting on a minting transaction to complete and be confirmed on the blockchain network. However, the custodial token platform 210 may perform a minting process with the liquidity contract 250 to maintain a balance between staked and wrapped tokens (e.g., to refill the tokens attributed to the users).

Accordingly, the user 205 may access the custodial token platform 210 and request to stake an amount of tokens associated with the user profile 230 via the custodial token platform. The amount of tokens may be locked by the custodial token platform 210 (and the platform may perform procedures to stake tokens), but the custodial token platform 210 may offer the user the wrapped token representing the staked tokens. Thus, the custodial token platform 210) may receive a request to wrap the staked crypto token. For example, the user 205 may request wrapping or to otherwise make transferrable, a staked crypto token, and the custodial token platform may associate a corresponding amount of wrapped tokens with the user account. The wrapped token attribution may attribute a representation of the staked crypto token value and may be transferrable within the custodial token platform 210 or via the blockchain network external to the custodial token platform 210. That is, the user may send the wrapped token to a wallet address external to the custodial token platform 210. As will be discussed herein, the wrapped crypto token may be unwrapped, which may result in the staked token be associated with the user profile 230. When conditions associated with the liquidity contract 250) are met, such as a request to stake tokens, the custodial token platform 210 may transact with the liquidity contract 250 to mint a corresponding amount of the wrapped token (e.g., based on the conversion rate). The liquidity contract 250 may transmit the wrapped crypto token to the token pool 245.

The wrapped token described herein may be based on cToken model, but it should be understood that some of the techniques described herein are applicable to other token models, such as aTokens. According to the cToken model, the wrapped tokens represent ownership of the underlying principal (e.g., the staked token) plus any rewards accrued on that principal, minus penalties (if any). Thus, the conversion ratio between the wrapped token and the underlying assets (principals+rewards−penalties) thus changes as a function of the rewards and penalties impacting the principal. As an example. Bob supplies 10 ETH to the custodial token platform 210 and receives 10 cbETH (e.g., wrapped token). After some time passes, Bob earns two ETH of rewards on his account. Bob's cbETH position remains at 10 cbETH (no change in supply held), but the position is now backed by 12 ETH, which changes the conversion rate of cbETH relative to ETH. Bob then removes his liquidity from the protocol, converting his 10 cbETH for 12 ETH. Thus, structured as a cToken, the wrapped token has rights to the underlying staked token and the accrued rewards and penalties. Changes in these underlying amounts have impacts on the conversion rate between the wrapped token and the staked token.

The conversion rate or ratio is the rate at which the wrapped token will be issued or redeemed relative to the amount of staked token being wrapped. The conversion ratio is a function of the amount of the token staked, any post-commission rewards earned, any penalties imposed, and a total wrapped token supply. The conversion rate may be pulled from both the smart contract (e.g., the liquidity contract 250) and an application programming interface (API) associated with the custodial token platform 210 (where the custodial token platform 210 informs the smart contract of the conversion rate). At first mint (e.g., premint), a 1:1 ratio between the staked token and the wrapped token may be established. Thus, at a high level, the conversion ratio at the total pool level (e.g., the token pool 245) is calculated as follows:

$$conversion rate = \frac{Total Underlying Wrapped Staked Token}{Total Wrapped Token Supply} ,$$

where Total Underlying Wrapped Staked Token=the staked token settled in wraps (e.g., contributed to the liquidity contract 250)−Staked token settled in unwrap+Net rewards. Total Wrapped Token Supply=wrapped token issued−wrapped token redeemed. Net rewards=inflationary protocol rewards+Transaction fees (tips) & other validator rewards−Penalties)−fees. In some cases, the custodial token platform 210 may take a fee (e.g., 25% fee) of the rewards.

Thus, the custodial token platform 210 may periodically assess an amount of eligible tokens staked on the custodial token platform 210 and may mint a corresponding amount of the wrapped token using the liquidity contract 250 in accordance with the current conversion rate. The wrapped token is minted on-chain to the designated receiver wallet. The wrapped token supplies may be updated based on the underlying staked token at a configured cadence (e.g., 4 hours).

As described herein, the conversion ratio may be dependent on penalties incurred via the underlying blockchain network. In the example of Ethereum, the consensus mechanism has several rules to protect the integrity of the network. If any of these rules are broken (voluntarily or not), a portion of staked ETH may be slashed. Some examples include validator downtime and double-signing.

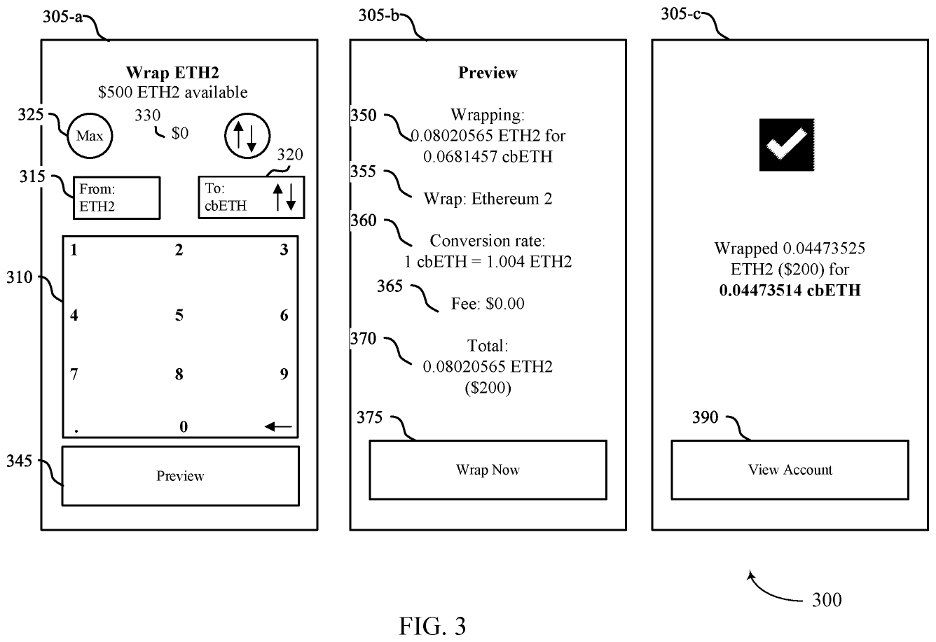

FIG. 3 illustrates an example of a user interface 300 of an application that supports transferring of liquid staking tokens in accordance with aspects of the present disclosure. The application may be associated with a custodial token platform, such as the custodial token platform 110 of FIG. 1 and the custodial token platform 210 of FIG. 2. More particularly, the application may be used to access a service provided by the custodial token platform, such as buying, trading, staking, sending, receiving, wrapping, and unwrapping crypto tokens.

The user interface 300 displays a wrap request 305-a, a wrap preview 305-b, and a wrap completion 305-c. The wrap request 305-a includes an interface indicating the crypto token requested to wrap (e.g., Wrap ETH2), the available quantity of the crypto token (e.g., staked crypto token) available for wrapping for the user (e.g., $500 ETH2), the conversion of the crypto token to the wrapped crypto token (e.g., From: ETH2 and To: cbETH).

In some examples, the interface may include a numeric pad 310, which the user may use to enter the amount of crypto token to convert. For example, the user may select an editable field of original crypto token 315 (e.g., staked crypto token, ETH2) and use the numeric pad 310 to enter the amount of staked crypto token to use from the available staked crypto token for converting into the wrapped crypto token 320. This amount may appear or be entered in an editable amount field 330. Accordingly, the amount field 330 may display the amount to be converted. In some examples, a field corresponding to the wrapped crypto token 320 may be selected and the user may use the numeric pad 310 to enter the amount of intended wrapped crypto token 320, which may automatically populate the original crypto token 315 that will be used to provide the intended amount of the wrapped crypto token 320. These amounts may be identified and populated based on a current conversion rate maintained by the custodial token platform.

In some examples, a maximum button 325 may be selected to populate the amount field 330 of staked crypto token (e.g., original crypto token 315) to be converted to the wrapped crypto token 320 with the maximum available staked crypto token (e.g., $500 ETH2). The editable amount field 330 may be populated with the maximum available staked crypto token in a single step. In some examples, a toggle 340 may be used to toggle whether the intended operation is a wrap or unwrap operation, thereby toggling the original crypto token 315 (e.g., from ETH2 to cbETH) and the wrapped crypto token 320 (e.g., from cbETH to ETH2). After selecting the amount of original crypto token 315 (e.g., ETH2) to be converted to the wrapped crypto token 320 (e.g., cbETH), a preview button 345 may be selected to preview the transaction.

In the wrap preview 305-b, the interface may display a wrapping indication 350 of the amount of staked crypto token (e.g., amount of original crypto token 315) that will be used from the user's account to provide an amount of wrapped crypto token 320 (e.g., converted crypto token). For example, for approximately 0.0802 ETH2 (e.g., staked crypto tokens), the user may receive approximately 0.068 cbETH (e.g., wrapped staked crypto tokens).

The user interface 300 may also display a wrapping type indication 355 of the original crypto token being converted. For example, the interface may indicate that Ether 2 is being wrapped (e.g., Wrap: Ether 2). The interface may also display a conversion rate 360 used for converting from a unit of original crypto token (e.g., 1 cbETH) to a unit of converted crypto token (e.g., 1.004 ETH2). The conversion rate 360 is the rate that is applied to generate the wrapping indication 350. If there are any fees associated with the wrapping transaction, the fees may be displayed at a fee field 365 of the user interface. In some examples, no fees are associated with wrapping. The interface may also display the total amount of wrapped crypto token 370 that is provided based on, for example, a product of the amount of original crypto token of the staked crypto token to be converted with the conversion rate. The total amount of wrapped crypto token 370 may also be indicated in the amount of crypto tokens based on a currency, such as the currency used to purchase a crypto token. To finalize the wrapping, the user may select a “wrap now” button 375 to perform the wrapping.

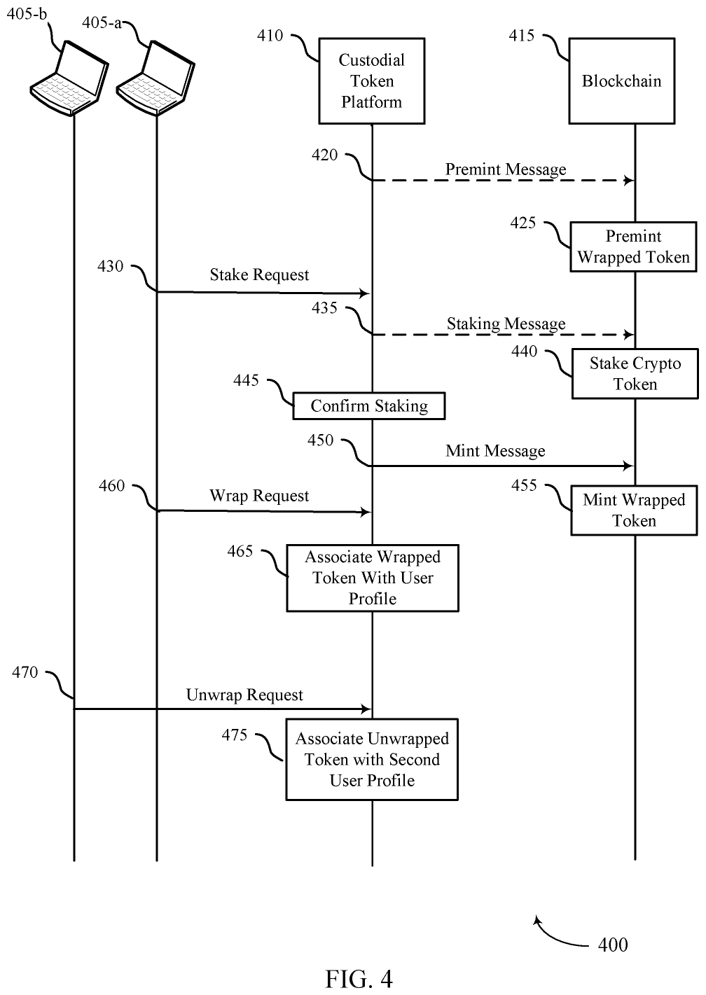

The user interface 300 may change to the wrap completion 305-c, which indicates an amount of original crypto token or the amount of original crypto token in a currency (e.g., 0.04473525 ETH2 ($200)) that was used to generate the amount of wrapped crypto token (e.g., 0.04473514 cbETH). The user may receive the wrapped crypto token with no waiting period or approximately no waiting period (e.g., without waiting on a corresponding minting procedure to be performed by the custodial token platform). For example, and as discussed with respect to FIG. 4, preminting to generate wrapped crypto token provides a reserved pool of available wrapped crypto token, and the reserve facilitates efficiently providing the wrapped crypto token immediately after the user requests wrapping the staked crypto token. In this manner, the user may not have wait for the process of the custodial token platform converting the user's respective staked crypto token.

The wrap completion 305-c may also display a symbol indicating a successful conversion or transaction (e.g., a checkmark symbol) or a failed conversion or transaction (e.g., an “x” symbol). In some examples, the user may select a view account button 390 to view a summary of the user's account, including currently held crypto tokens, staked crypto tokens, wrapped crypto tokens, and so forth. The account associated with the user may display a credit (e.g., withdraw) of crypto token account or balance (e.g., for ETH2) and a debit (e.g., deposit) to the user's wrapped crypto token account or balance (e.g., for cbETH).

FIG. 4 illustrates an example of a process flow 400 that supports transferring of liquid staking tokens in accordance with aspects of the present disclosure. The process flow 400 includes a first user device 405-a, a second user device 405-b, a custodial token platform 410, and a blockchain 415, which may be examples of the corresponding devices or systems as described herein with respect to FIGS. 1 through 3. In the following description of the process flow 400, the operations between the user devices 405, the custodial token platform 410, and the blockchain 415 may be transmitted in a different order than the example order shown, or the operations performed may be performed in different orders or at different times. Some operations may also be omitted from the process flow 400, and other operations may be added to the process flow 400.

At 420, the custodial token platform 410 may broadcast a premint message to premint wrapped crypto tokens. For example, the custodial token platform 410 may deploy, to the blockchain distributed data store (e.g., the blockchain 415), a self-executing program to premint wrapped crypto tokens (e.g., the liquidity contract 250 of FIG. 2). Preminting includes a process to mint crypto tokens to provide liquidity for wrapping after a request for wrapping a crypto token. The preminting of existing staked crypto tokens to generate the wrapped crypto tokens may occur prior to or without a request for wrapping, for example, and may be performed in anticipation of future wrapping requests. The custodial token platform 410 may store or access a reserved pool of the preminted crypto token in order to fulfill a request for wrapped crypto tokens instead waiting on a minting process to complete in response to a wrapping request from the user. Accordingly, at 425, the blockchain 415 may premint the wrapped token responsive to the premint message from the custodial token platform 410, and the preminted tokens may be associated with wallet address associated with the custodial token platform 410 as the token pool.

At 430, the custodial token platform 410 may receive via a user interface (e.g., at the user device 405-a or 405-b) associated with the custodial token platform 410, a stake request for staking crypto currency associated with the user. At 435, the custodial token platform 410 may transmit a staking message to the blockchain 415 for fulfilling the staking request. Self-executing programs of the blockchain 415 may stake crypto tokens in response to the request. In some examples, the staking message may include a crypto token type, an amount of crypto token to stake, and so forth. Accordingly, at 440, the blockchain 415 may stake the crypto token indicated in the staking message. Additionally, in response to a staking request, the custodial token platform 410 may associate a staked token to the user profile associated with the requesting the stake. This staked token may not be transferrable or used to transact via the blockchain network. That is, the staked token may be locked.

At 445, the custodial token platform 410 may confirm the staking of the requested amount of crypto tokens associated with the staking user of the user device 405. That is, the custodial token platform may confirm that a staking delegation message is confirmed via the blockchain network. At 450, the custodial token platform 410 may broadcast a mint message to the blockchain 415 (e.g., the corresponding blockchain network), and the mint message may be configured to call the self-executing program to mint additional wrapped tokens. In some examples, additional wrapped crypto tokens may be minted to add wrapped crypto tokens to the pool of wrapped crypto tokens. In particular, additional requests for wrapped crypto tokens may occur after a user stakes crypto tokens. In some examples, when a user stakes crypto tokens, a new opportunity exists to request a wrapped crypto token. In some examples, the staked crypto token may be used to generate the wrapped crypto token to fulfill future requests for the wrapped crypto tokens. Accordingly, at 455, the blockchain 415 may mint wrapped crypto tokens. As such, may add wrapped crypto tokens to the pool of wrapped crypt tokens. Accordingly, in response to staking, the custodial token platform 410 may mint additional wrapped tokens and add the wrapped tokens to the pool to maintain pool liquidity. In some examples, the blockchain 415 may mint wrapped crypto tokens based on one or more factors, such as time or a threshold. For example, minting may occur periodically or based on a trigger event, such as when the reserve of wrapped staked tokens in the wrapped crypto token pool is below a threshold, when the quantity of new staking requests is above a threshold or within a time frame, and so forth.

At 460, the custodial token platform 410 may receive a wrap request for wrapping staked crypto tokens from the user device 405 (e.g., the first user device 405-a or the second user device 405-b) associated with the user. In some examples, this request to wrap staked crypto tokens may occur after the stake request at 430 (e.g., prior to staking and minting completing on the blockchain 415 at 435 to 455). Accordingly, at 465, the custodial token platform 410 may associate wrapped crypto token with the user profile (e.g., and the user or the user device 405). For example, the request for wrapped crypto tokens may be immediately fulfilled by retrieving the wrapped crypto tokens from the pool of wrapped crypto tokens, which are available based on minting or preminting. In some examples, converting the staked crypto token to the wrapped crypto token may be associated with one or more platform fees. Converting from the staked crypto token to the wrapped crypto token may also be associated with a conversion rate that results in an unequal ratio of the staked crypto token to the wrapped crypto token (e.g., not a 1:1 ratio). As such, the user may receive less than one or greater than one wrapped crypto token value (e.g., cbETH) for one staked crypto token value (e.g., ETH2). The conversion rate, as well as the amount of wrapped crypto token to be received may be provided to the user prior to the wrapping, as described with respect to FIG. 3. In some examples, in response to receiving the wrap request, the custodial token platform may lock the user's staked tokens.

At 470), the custodial token platform 410 may receive an unwrap request from the user device 405. In some examples, the user device 405 requesting unwrapping may be the same user device that requested staking and wrapping, such as the first user device 405-a. In some examples, the user device 405 requesting unwrapping may a different user device associated with a different user, such as the second user device 405-b associated with a second user. Accordingly, various users may request unwrapping the wrapped crypto token associated with the respective user in order to revert back to the staked crypto token. In this manner, wrapping staked crypto token and also enabling a different user (e.g., non-staking user) to unwrap the transferred wrapped crypto token, allows easier transferability and liquidity of staked crypto tokens. Accordingly, at 475, the custodial token platform 410 may associate the unwrapped token (e.g., staked crypto token and rewards associated with the staked crypto token) with a second user profile of the second user device 405-b. The amount associated may be based on the conversion ratio between the wrapped token and the staked token, as described herein.

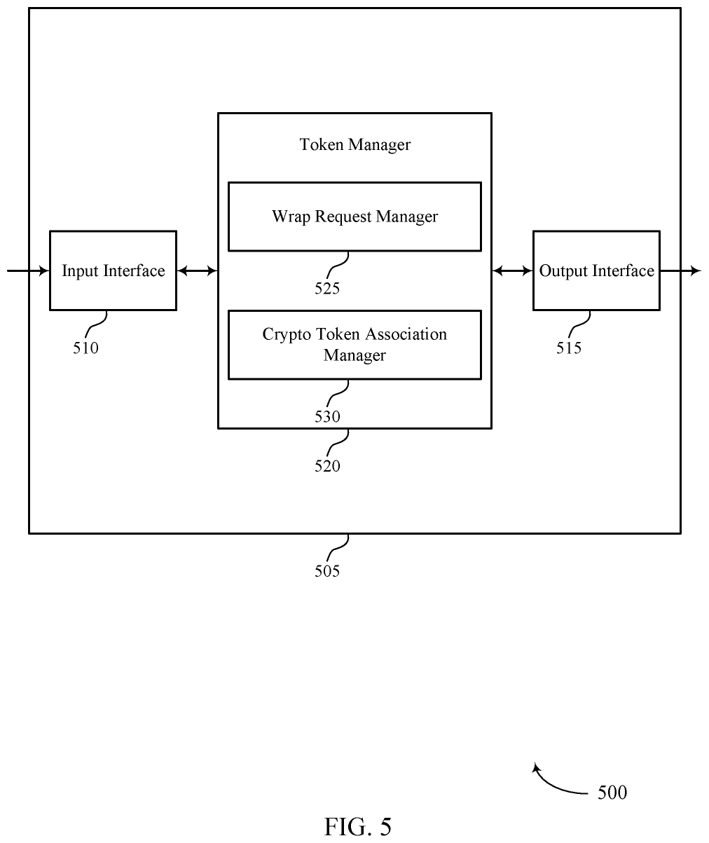

FIG. 5 illustrates a block diagram 500 of a system 505 that supports exchange of liquid staking tokens in accordance with aspects of the present disclosure. The system 505 may include an input interface 510, an output interface 515, and a token manager 520. The system 505 may also include a processor. Each of these components may be in communication with one another (e.g., via one or more buses, communications links, communications interfaces, or any combination thereof).

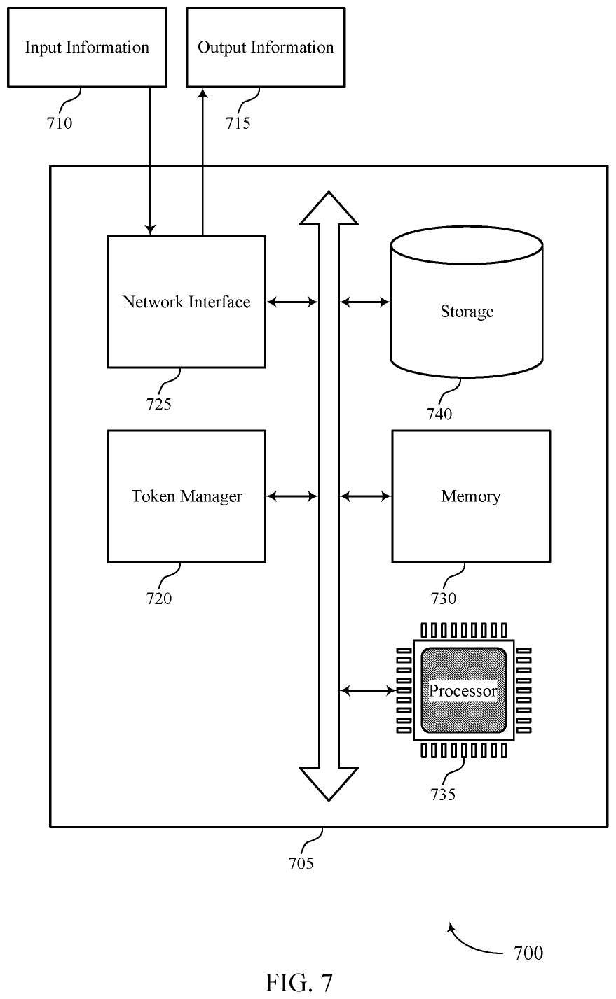

The input interface 510 may manage input signaling for the system 505. For example, the input interface 510 may receive input signaling (e.g., messages, packets, data, instructions, commands, or any other form of encoded information) from other systems or devices. The input interface 510 may send signaling corresponding to (e.g., representative of or otherwise based on) such input signaling to other components of the system 505 for processing. For example, the input interface 510 may transmit such corresponding signaling to the token manager 520 to support exchange of liquid staking tokens. In some cases, the input interface 510 may be a component of a network interface 725 as described with reference to FIG. 7.

The output interface 515 may manage output signaling for the system 505. For example, the output interface 515 may receive signaling from other components of the system 505, such as the token manager 520, and may transmit such output signaling corresponding to (e.g., representative of or otherwise based on) such signaling to other systems or devices. In some cases, the output interface 515 may be a component of a network interface 725 as described with reference to FIG. 7.

For example, the token manager 520 may include a wrap request manager 525 a crypto token association manager 530, or any combination thereof. In some examples, the token manager 520, or various components thereof, may be configured to perform various operations (e.g., receiving, monitoring, transmitting) using or otherwise in cooperation with the input interface 510, the output interface 515, or both. For example, the token manager 520 may receive information from the input interface 510, send information to the output interface 515, or be integrated in combination with the input interface 510, the output interface 515, or both to receive information, transmit information, or perform various other operations as described herein.

The token manager 520 may support data processing in accordance with examples as disclosed herein. The wrap request manager 525 may be configured as or otherwise support a means for receiving, at a custodial token platform from a first user profile, a first request to wrap a first amount of a first crypto token that is staked in accordance with a protocol associated with a blockchain network supported distributed data store. The crypto token association manager 530 may be configured as or otherwise support a means for associating, after receiving the first request, a second amount of the second crypto token with the first user profile, the second crypto token being transferrable via the protocol associated with the blockchain network supported distributed data store and being minted by a self-executing program deployed to the blockchain network supported distributed data store, the second amount being based on a first value of a current conversion ratio between the first crypto token and the second crypto token. The wrap request manager 525 may be configured as or otherwise support a means for receiving, at the custodial token platform from a second user profile, a second request to unwrap the second crypto token. The crypto token association manager 530) may be configured as or otherwise support a means for associating, after receiving the second request, the second user profile with a third amount of the first crypto token, the third amount being based on a second value of the current conversion ratio between the first crypto token and the second crypto token.

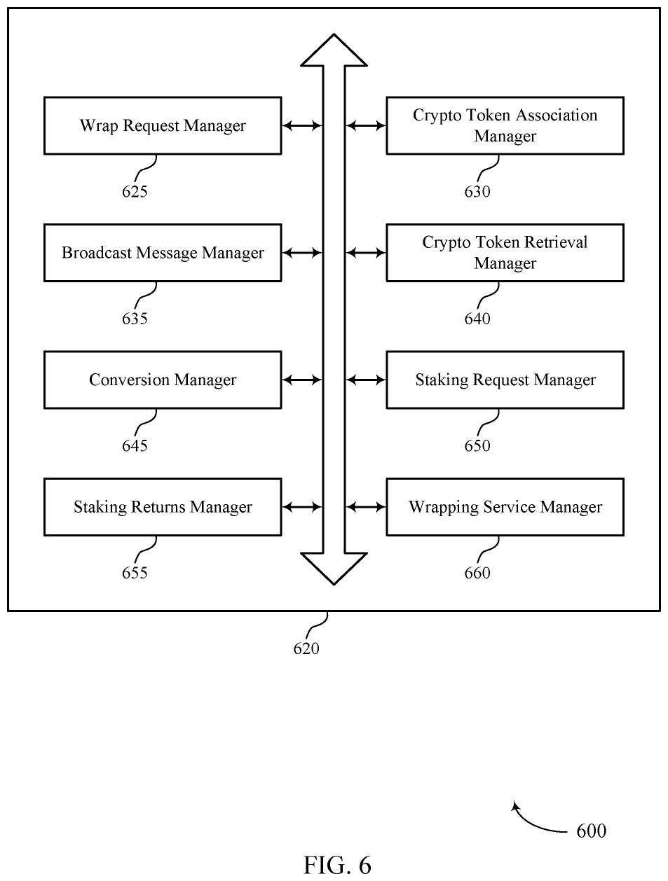

FIG. 6 illustrates a block diagram 600 of a token manager 620 that supports exchange of liquid staking tokens in accordance with aspects of the present disclosure. The token manager 620 may be an example of aspects of a token manager or a token manager 520, or both, as described herein. The token manager 620, or various components thereof, may be an example of means for performing various aspects of exchange of liquid staking tokens as described herein. For example, the token manager 620 may include a wrap request manager 625, a crypto token association manager 630, a broadcast message manager 635, a crypto token retrieval manager 640, a conversion manager 645, a staking request manager 650, a staking returns manager 655, a wrapping service manager 660), or any combination thereof. Each of these components may be in communication with one another (e.g., via one or more buses, communications links, communications interfaces, or any combination thereof).

The token manager 620 may support data processing in accordance with examples as disclosed herein. The wrap request manager 625 may be configured as or otherwise support a means for receiving, at a custodial token platform from a first user profile, a first request to wrap a first amount of a first crypto token that is staked in accordance with a protocol associated with a blockchain network supported distributed data store. The crypto token association manager 630 may be configured as or otherwise support a means for associating, after receiving the first request, a second amount of the second crypto token with the first user profile, the second crypto token being transferrable via the protocol associated with the blockchain network supported distributed data store and being minted by a self-executing program deployed to the blockchain network supported distributed data store, the second amount being based on a first value of a current conversion ratio between the first crypto token and the second crypto token. In some examples, the wrap request manager 625 may be configured as or otherwise support a means for receiving, at the custodial token platform from a second user profile, a second request to unwrap the second crypto token. In some examples, the crypto token association manager 630 may be configured as or otherwise support a means for associating, after receiving the second request, the second user profile with a third amount of the first crypto token, the third amount being based on a second value of the current conversion ratio between the first crypto token and the second crypto token.

In some examples, the broadcast message manager 635 may be configured as or otherwise support a means for broadcasting, to the blockchain network, a message that is configured to cause the self-executing program to mint a total supply of the second crypto token that is equal to a total supply of the first crypto token staked via the custodial token platform, wherein the second amount is retrieved from one or more token pools managed by the custodial token platform that are attributed with the total supply of the second crypto token.

In some examples, to support associating the second amount with the first user profile, the crypto token retrieval manager 640 may be configured as or otherwise support a means for retrieving the second amount of the second crypto token from a token pool managed by the custodial token platform, wherein the token pool includes a supply of the second crypto token that is minted by the self-executing program deployed to the blockchain network.

In some examples, the broadcast message manager 635 may be configured as or otherwise support a means for broadcasting a first message that is configured to delegate the first amount of the first crypto token to a staking self-executing program associated with the custodial token platform. In some examples, the broadcast message manager 635 may be configured as or otherwise support a means for broadcasting, after confirmation of the first message via the blockchain network and before receiving the first request, a second message that is configured to cause the self-executing program to mint the second amount of the second crypto token and attribute the second amount to an address associated with the custodial token platform.

In some examples, the staking request manager 650 may be configured as or otherwise support a means for receiving, at the custodial token platform, a staking request to stake the first amount of the first crypto token via the custodial token platform, wherein the first message is broadcast based at least in part on receiving the staking request. In some examples, the staking returns manager 655 may be configured as or otherwise support a means for activating, after receiving the staking request and prior to confirmation of the first message, staking returns associated with the first user profile for the first amount of the first crypto token. In some examples, the wrapping service manager 660 may be configured as or otherwise support a means for activating, after receiving the staking request and prior to confirmation of the first message, access to a service for wrapping the first amount of the first crypto token.

In some examples, the first amount of the first crypto token is locked for staking for a time period after receiving the staking request.

In some examples, the conversion manager 645 may be configured as or otherwise support a means for determining the first value or the second value of the current conversion ratio based least in part on a ratio between a total supply of the first crypto token that is staked in accordance with the protocol and a total supply of the second crypto token that is minted by the self-executing program.

In some examples, the total supply of the first crypto token includes a staking return for staking the first crypto token in accordance with the protocol, a slashing penalty associated with staking the first crypto token in accordance with the protocol, or both.

In some examples, the broadcast message manager 635 may be configured as or otherwise support a means for broadcasting, after associating the second amount of the second crypto token with the first user profile, a message that is configured to transfer one or more of the second crypto token from the first user profile of the custodial token platform to an address that is external to the custodial token platform, wherein the first user profile is subject to staking returns associated with the first crypto token after broadcasting the message.

FIG. 7 illustrates a diagram 700 including a system 705 that supports exchange of liquid staking tokens in accordance with aspects of the present disclosure. The system 705 may be an example of or include the components of a system 505 as described herein. The system 705 may include components for bi-directional voice and data communications including components for transmitting and receiving communications, such as a token manager 720, an input information 710, an output information 715, a network interface 725, a memory 730, a processor 735, and a storage 740. These components may be in electronic communication or otherwise coupled (e.g., operatively, communicatively, functionally, electronically, electrically: via one or more buses, communications links, communications interfaces, or any combination thereof).

The network interface 725 may enable the system 705 to exchange information (e.g., input information 710, output information 715, or both) with other systems or devices (not shown). For example, the network interface 725 may enable the system 705 to connect to a network (e.g., a network 120 as described herein). The network interface 725 may include one or more wireless network interfaces, one or more wired network interfaces, or any combination thereof. In some examples, the network interface 725 may be an example of may be an example of aspects of one or more components described with reference to FIG. 1, such as one or more network interfaces.

Memory 730 may include RAM, ROM, or both. The memory 730 may store computer-readable, computer-executable software including instructions that, when executed, cause the processor 735 to perform various functions described herein. In some cases, the memory 730 may contain, among other things, a basic input/output system (BIOS), which may control basic hardware or software operation such as the interaction with peripheral components or devices. In some cases, the memory 730 may be an example of aspects of one or more components described with reference to FIG. 1, such as one or more memories.

The processor 735 may include an intelligent hardware device, (e.g., a general-purpose processor, a digital signal processor (DSP), a central processing unit (CPU), a microcontroller, an application specific integrated circuit (ASIC), a field programmable gate array (FPGA), a programmable logic device, a discrete gate or transistor logic component, a discrete hardware component, or any combination thereof). The processor 735 may be configured to execute computer-readable instructions stored in a memory 730 to perform various functions (e.g., functions or tasks supporting exchange of liquid staking tokens). Though a single processor 735 is depicted in the example of FIG. 7, it is to be understood that the system 705 may include any quantity of one or more of processors 735 and that a group of processors 735 may collectively perform one or more functions ascribed herein to a processor, such as the processor 735. In some cases, the processor 735 may be an example of aspects of one or more components described with reference to FIG. 1, such as one or more processors.

Storage 740 may be configured to store data that is generated, processed, stored, or otherwise used by the system 705. In some cases, the storage 740 may include one or more hard disc drives (HDDs), one or more solid state drives (SSDs), or both. In some examples, the storage 740 may be an example of a single database, a distributed database, multiple distributed databases, a data store, a data lake, or an emergency backup database. In some examples, the storage 740) may be an example of one or more components described with reference to FIG. 1, such as one or more network disks.

The token manager 720) may support data processing in accordance with examples as disclosed herein. For example, the token manager 720 may be configured as or otherwise support a means for receiving, at a custodial token platform from a first user profile, a first request to wrap a first amount of a first crypto token that is staked in accordance with a protocol associated with a blockchain network supported distributed data store. The token manager 720) may be configured as or otherwise support a means for associating, after receiving the first request, a second amount of the second crypto token with the first user profile, the second crypto token being transferrable via the protocol associated with the blockchain network supported distributed data store and being minted by a self-executing program deployed to the blockchain network supported distributed data store, the second amount being based on a first value of a current conversion ratio between the first crypto token and the second crypto token. The token manager 720 may be configured as or otherwise support a means for receiving, at the custodial token platform from a second user profile, a second request to unwrap the second crypto token. The token manager 720 may be configured as or otherwise support a means for associating, after receiving the second request, the second user profile with a third amount of the first crypto token, the third amount being based on a second value of the current conversion ratio between the first crypto token and the second crypto token.

By including or configuring the token manager 720 in accordance with examples as described herein, the system 705 may support techniques for efficiently providing wrapped crypto tokens immediately after a request for the wrapped crypto tokens, as well facilitating a staking user or another user of the wrapped crypto token in reverting the wrapped crypto token to a staked crypto token. The techniques described herein for wrapping crypto tokens and unwrapping crypto tokens may also increase liquidity and transferability of staked crypto tokens.

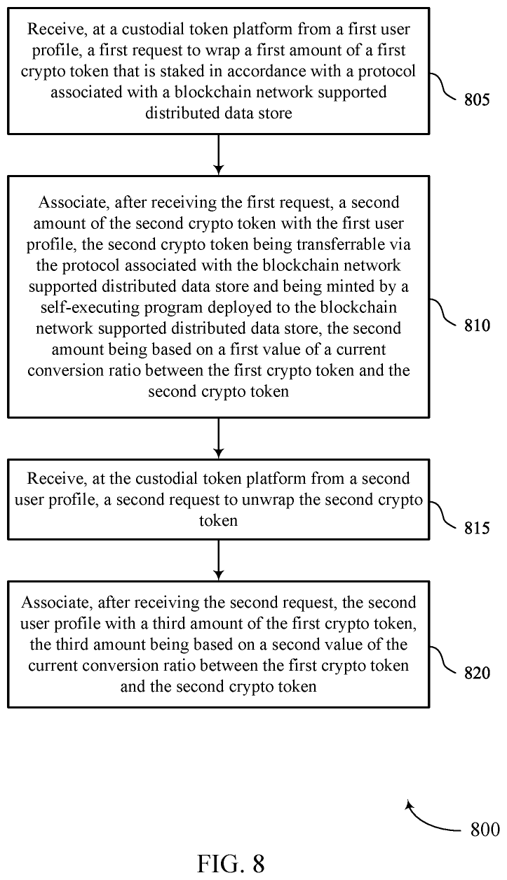

FIG. 8 illustrates a flowchart showing a method 800 that supports exchange of liquid staking tokens in accordance with aspects of the present disclosure. The operations of the method 800 may be implemented by a custodial token platform or its components as described herein. For example, the operations of the method 800 may be performed by a custodial token platform as described with reference to FIGS. 1 through 7. In some examples, a custodial token platform may execute a set of instructions to control the functional elements of the custodial token platform to perform the described functions. Additionally, or alternatively, the custodial token platform may perform aspects of the described functions using special-purpose hardware.

At 805, the method may include receiving, at a custodial token platform from a first user profile, a first request to wrap a first amount of a first crypto token that is staked in accordance with a protocol associated with a blockchain network supported distributed data store. The operations of 805 may be performed in accordance with examples as disclosed herein. In some examples, aspects of the operations of 805 may be performed by a wrap request manager 625 as described with reference to FIG. 6.

At 810, the method may include associating, after receiving the first request, a second amount of the second crypto token with the first user profile, the second crypto token being transferrable via the protocol associated with the blockchain network supported distributed data store and being minted by a self-executing program deployed to the blockchain network supported distributed data store, the second amount being based on a first value of a current conversion ratio between the first crypto token and the second crypto token. The operations of 810 may be performed in accordance with examples as disclosed herein. In some examples, aspects of the operations of 810 may be performed by a crypto token association manager 630 as described with reference to FIG. 6.

At 815, the method may include receiving, at the custodial token platform from a second user profile, a second request to unwrap the second crypto token. The operations of 815 may be performed in accordance with examples as disclosed herein. In some examples, aspects of the operations of 815 may be performed by a wrap request manager 625 as described with reference to FIG. 6.

At 820, the method may include associating, after receiving the second request, the second user profile with a third amount of the first crypto token, the third amount being based on a second value of the current conversion ratio between the first crypto token and the second crypto token. The operations of 820 may be performed in accordance with examples as disclosed herein. In some examples, aspects of the operations of 820 may be performed by a crypto token association manager 630) as described with reference to FIG. 6.

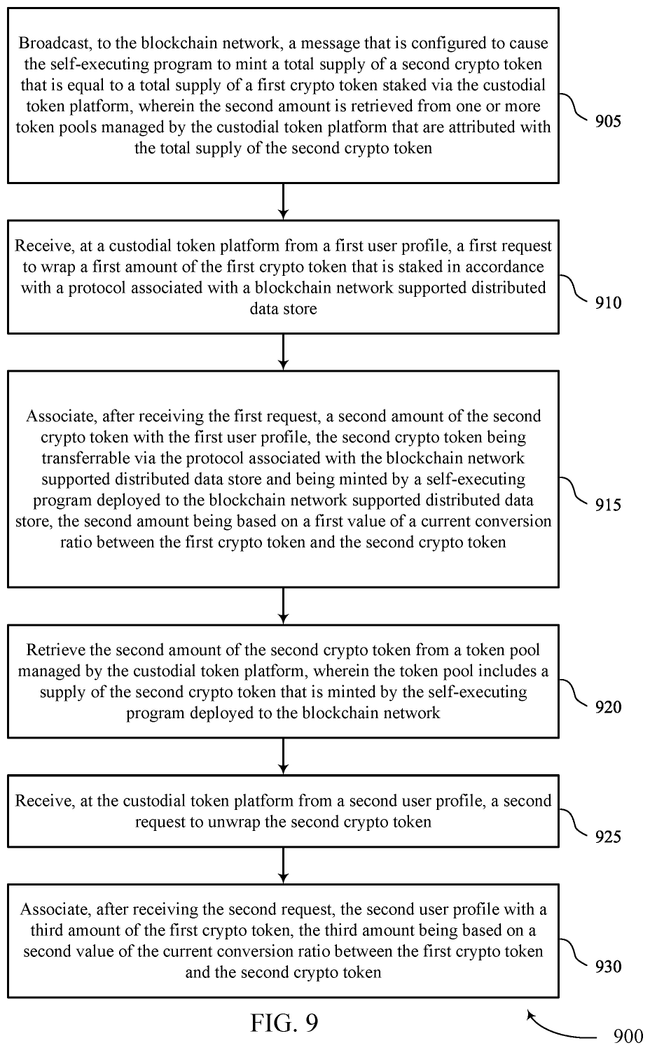

FIG. 9 shows a flowchart illustrating a method 900 that supports exchange of liquid staking tokens in accordance with aspects of the present disclosure. The operations of the method 900 may be implemented by a custodial token platform or its components as described herein. For example, the operations of the method 900 may be performed by a custodial token platform as described with reference to FIGS. 1 through 7. In some examples, a custodial token platform may execute a set of instructions to control the functional elements of the wireless custodial token platform to perform the described functions. Additionally, or alternatively, the wireless custodial token platform may perform aspects of the described functions using special-purpose hardware.

At 905, the method may include broadcasting, to the blockchain network, a message that is configured to cause the self-executing program to mint a total supply of a second crypto token that is equal to a total supply of a first crypto token staked via the custodial token platform, wherein the second amount is retrieved from one or more token pools managed by the custodial token platform that are attributed with the total supply of the second crypto token. The operations of 905 may be performed in accordance with examples as disclosed herein. In some examples, aspects of the operations of 905 may be performed by a broadcast message manager 635 as described with reference to FIG. 6.

At 910, the method may include receiving, at a custodial token platform from a first user profile, a first request to wrap a first amount of the first crypto token that is staked in accordance with a protocol associated with a blockchain network supported distributed data store. The operations of 910 may be performed in accordance with examples as disclosed herein. In some examples, aspects of the operations of 910 may be performed by a wrap request manager 625 as described with reference to FIG. 6.

At 915, the method may include associating, after receiving the first request, a second amount of the second crypto token with the first user profile, the second crypto token being transferrable via the protocol associated with the blockchain network supported distributed data store and being minted by a self-executing program deployed to the blockchain network supported distributed data store, the second amount being based on a first value of a current conversion ratio between the first crypto token and the second crypto token. The operations of 915 may be performed in accordance with examples as disclosed herein. In some examples, aspects of the operations of 915 may be performed by a crypto token association manager 630 as described with reference to FIG. 6.

At 920, the method may include retrieving the second amount of the second crypto token from a token pool managed by the custodial token platform, wherein the token pool includes a supply of the second crypto token that is minted by the self-executing program deployed to the blockchain network. The operations of 920 may be performed in accordance with examples as disclosed herein. In some examples, aspects of the operations of 920 may be performed by a crypto token retrieval manager 640 as described with reference to FIG. 6.

At 925, the method may include receiving, at the custodial token platform from a second user profile, a second request to unwrap the second crypto token. The operations of 925 may be performed in accordance with examples as disclosed herein. In some examples, aspects of the operations of 925 may be performed by a wrap request manager 625 as described with reference to FIG. 6.

At 930, the method may include associating, after receiving the second request, the second user profile with a third amount of the first crypto token, the third amount being based on a second value of the current conversion ratio between the first crypto token and the second crypto token. The operations of 930 may be performed in accordance with examples as disclosed herein. In some examples, aspects of the operations of 930 may be performed by a crypto token association manager 630 as described with reference to FIG. 6.

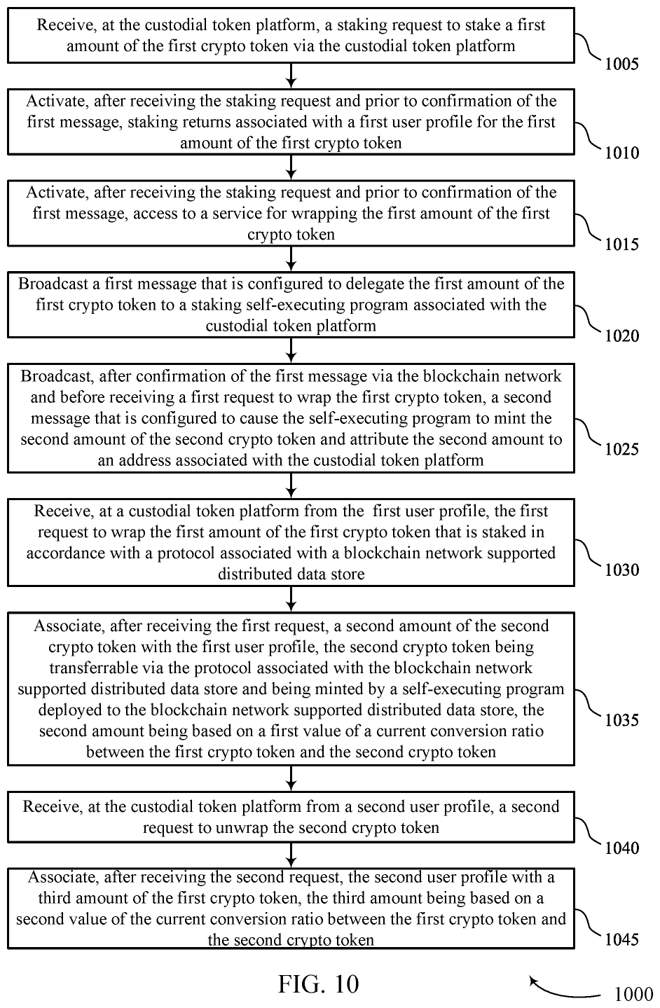

FIG. 10 shows a flowchart illustrating a method 1000 that supports exchange of liquid staking tokens in accordance with aspects of the present disclosure. The operations of the method 1000 may be implemented by a custodial token platform or its components as described herein. For example, the operations of the method 1000 may be performed by a custodial token platform as described with reference to FIGS. 1 through 7. In some examples, a custodial token platform may execute a set of instructions to control the functional elements of the wireless custodial token platform to perform the described functions. Additionally, or alternatively, the wireless custodial token platform may perform aspects of the described functions using special-purpose hardware.

At 1005, the method may include receiving, at the custodial token platform, a staking request to stake a first amount of a first crypto token via the custodial token platform. The operations of 1005 may be performed in accordance with examples as disclosed herein. In some examples, aspects of the operations of 1005 may be performed by a staking request manager 650 as described with reference to FIG. 6.

At 1010, the method may include activating, after receiving the staking request and prior to confirmation of the first message, staking returns associated with a first user profile for the first amount of the first crypto token. The operations of 1010 may be performed in accordance with examples as disclosed herein. In some examples, aspects of the operations of 1010 may be performed by a staking returns manager 655 as described with reference to FIG. 6.

At 1015, the method may include activating, after receiving the staking request and prior to confirmation of the first message, access to a service for wrapping the first amount of the first crypto token. The operations of 1015 may be performed in accordance with examples as disclosed herein. In some examples, aspects of the operations of 1015 may be performed by a wrapping service manager 660 as described with reference to FIG. 6.

At 1020, the method may include broadcasting a first message that is configured to delegate the first amount of the first crypto token to a staking self-executing program associated with the custodial token platform. The operations of 1020 may be performed in accordance with examples as disclosed herein. In some examples, aspects of the operations of 1020 may be performed by a broadcast message manager 635 as described with reference to FIG. 6.

At 1025, the method may include broadcasting, after confirmation of the first message via the blockchain network and before receiving a first request to wrap the first crypto token, a second message that is configured to cause the self-executing program to mint the second amount of the second crypto token and attribute the second amount to an address associated with the custodial token platform. The operations of 1025 may be performed in accordance with examples as disclosed herein. In some examples, aspects of the operations of 1025 may be performed by a broadcast message manager 635 as described with reference to FIG. 6.

At 1030, the method may include receiving, at a custodial token platform from a first user profile, a first request to wrap the first amount of the first crypto token that is staked in accordance with a protocol associated with a blockchain network supported distributed data store. The operations of 1030 may be performed in accordance with examples as disclosed herein. In some examples, aspects of the operations of 1030 may be performed by a wrap request manager 625 as described with reference to FIG. 6.

At 1035, the method may include associating, after receiving the first request, a second amount of the second crypto token with the first user profile, the second crypto token being transferrable via the protocol associated with the blockchain network supported distributed data store and being minted by a self-executing program deployed to the blockchain network supported distributed data store, the second amount being based on a first value of a current conversion ratio between the first crypto token and the second crypto token. The operations of 1035 may be performed in accordance with examples as disclosed herein. In some examples, aspects of the operations of 1035 may be performed by a crypto token association manager 630 as described with reference to FIG. 6.

At 1040, the method may include receiving, at the custodial token platform from a second user profile, a second request to unwrap the second crypto token. The operations of 1040 may be performed in accordance with examples as disclosed herein. In some examples, aspects of the operations of 1040 may be performed by a wrap request manager 625 as described with reference to FIG. 6.

At 1045, the method may include associating, after receiving the second request, the second user profile with a third amount of the first crypto token, the third amount being based on a second value of the current conversion ratio between the first crypto token and the second crypto token. The operations of 1045 may be performed in accordance with examples as disclosed herein. In some examples, aspects of the operations of 1045 may be performed by a crypto token association manager 630 as described with reference to FIG. 6.

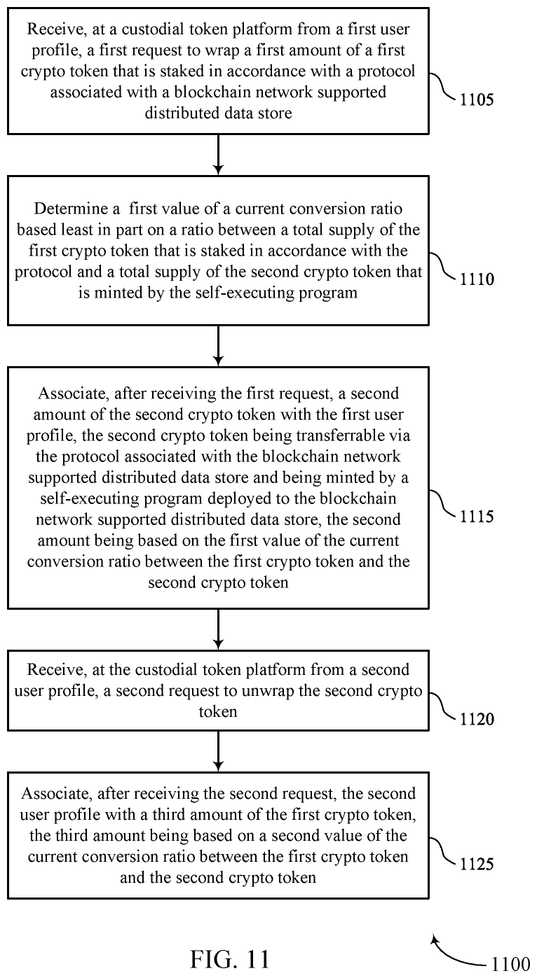

FIG. 11 shows a flowchart illustrating a method 1100 that supports exchange of liquid staking tokens in accordance with aspects of the present disclosure. The operations of the method 1100 may be implemented by a custodial token platform or its components as described herein. For example, the operations of the method 1100 may be performed by a custodial token platform as described with reference to FIGS. 1 through 7. In some examples, a custodial token platform may execute a set of instructions to control the functional elements of the wireless custodial token platform to perform the described functions. Additionally, or alternatively, the wireless custodial token platform may perform aspects of the described functions using special-purpose hardware.

At 1105, the method may include receiving, at a custodial token platform from a first user profile, a first request to wrap a first amount of a first crypto token that is staked in accordance with a protocol associated with a blockchain network supported distributed data store. The operations of 1105 may be performed in accordance with examples as disclosed herein. In some examples, aspects of the operations of 1105 may be performed by a wrap request manager 625 as described with reference to FIG. 6.

At 1110, the method may include determining a first value of a current conversion ratio based least in part on a ratio between a total supply of the first crypto token that is staked in accordance with the protocol and a total supply of the second crypto token that is minted by the self-executing program. The operations of 1110 may be performed in accordance with examples as disclosed herein. In some examples, aspects of the operations of 1110 may be performed by a conversion manager 645 as described with reference to FIG. 6.

At 1115, the method may include associating, after receiving the first request, a second amount of the second crypto token with the first user profile, the second crypto token being transferrable via the protocol associated with the blockchain network supported distributed data store and being minted by a self-executing program deployed to the blockchain network supported distributed data store, the second amount being based on the first value of the current conversion ratio between the first crypto token and the second crypto token. The operations of 1115 may be performed in accordance with examples as disclosed herein. In some examples, aspects of the operations of 1115 may be performed by a crypto token association manager 630 as described with reference to FIG. 6.

At 1120, the method may include receiving, at the custodial token platform from a second user profile, a second request to unwrap the second crypto token. The operations of 1120 may be performed in accordance with examples as disclosed herein. In some examples, aspects of the operations of 1120 may be performed by a wrap request manager 625 as described with reference to FIG. 6.

At 1125, the method may include associating, after receiving the second request, the second user profile with a third amount of the first crypto token, the third amount being based on a second value of the current conversion ratio between the first crypto token and the second crypto token. The operations of 1125 may be performed in accordance with examples as disclosed herein. In some examples, aspects of the operations of 1125 may be performed by a crypto token association manager 630 as described with reference to FIG. 6.

A method for data processing is described. The method may include receiving, at a custodial token platform from a first user profile, a first request to wrap a first amount of a first crypto token that is staked in accordance with a protocol associated with a blockchain network supported distributed data store, associating, after receiving the first request, a second amount of the second crypto token with the first user profile, the second crypto token being transferrable via the protocol associated with the blockchain network supported distributed data store and being minted by a self-executing program deployed to the blockchain network supported distributed data store, the second amount being based on a first value of a current conversion ratio between the first crypto token and the second crypto token, receiving, at the custodial token platform from a second user profile, a second request to unwrap the second crypto token, and associating, after receiving the second request, the second user profile with a third amount of the first crypto token, the third amount being based on a second value of the current conversion ratio between the first crypto token and the second crypto token.

An apparatus for data processing is described. The apparatus may include a processor, memory coupled with the processor, and instructions stored in the memory. The instructions may be executable by the processor to cause the apparatus to receive, at a custodial token platform from a first user profile, a first request to wrap a first amount of a first crypto token that is staked in accordance with a protocol associated with a blockchain network supported distributed data store, associate, after receiving the first request, a second amount of the second crypto token with the first user profile, the second crypto token being transferrable via the protocol associated with the blockchain network supported distributed data store and being minted by a self-executing program deployed to the blockchain network supported distributed data store, the second amount being based on a first value of a current conversion ratio between the first crypto token and the second crypto token, receive, at the custodial token platform from a second user profile, a second request to unwrap the second crypto token, and associate, after receiving the second request, the second user profile with a third amount of the first crypto token, the third amount being based on a second value of the current conversion ratio between the first crypto token and the second crypto token.

Another apparatus for data processing is described. The apparatus may include means for receiving, at a custodial token platform from a first user profile, a first request to wrap a first amount of a first crypto token that is staked in accordance with a protocol associated with a blockchain network supported distributed data store, means for associating, after receiving the first request, a second amount of the second crypto token with the first user profile, the second crypto token being transferrable via the protocol associated with the blockchain network supported distributed data store and being minted by a self-executing program deployed to the blockchain network supported distributed data store, the second amount being based on a first value of a current conversion ratio between the first crypto token and the second crypto token, means for receiving, at the custodial token platform from a second user profile, a second request to unwrap the second crypto token, and means for associating, after receiving the second request, the second user profile with a third amount of the first crypto token, the third amount being based on a second value of the current conversion ratio between the first crypto token and the second crypto token.

A non-transitory computer-readable medium storing code for data processing is described. The code may include instructions executable by a processor to receive, at a custodial token platform from a first user profile, a first request to wrap a first amount of a first crypto token that is staked in accordance with a protocol associated with a blockchain network supported distributed data store, associate, after receiving the first request, a second amount of the second crypto token with the first user profile, the second crypto token being transferrable via the protocol associated with the blockchain network supported distributed data store and being minted by a self-executing program deployed to the blockchain network supported distributed data store, the second amount being based on a first value of a current conversion ratio between the first crypto token and the second crypto token, receive, at the custodial token platform from a second user profile, a second request to unwrap the second crypto token, and associate, after receiving the second request, the second user profile with a third amount of the first crypto token, the third amount being based on a second value of the current conversion ratio between the first crypto token and the second crypto token.

Some examples of the method, apparatuses, and non-transitory computer-readable medium described herein may further include operations, features, means, or instructions for broadcasting, to the blockchain network, a message that may be configured to cause the self-executing program to mint a total supply of the second crypto token that may be equal to a total supply of the first crypto token staked via the custodial token platform, wherein the second amount may be retrieved from one or more token pools managed by the custodial token platform that may be attributed with the total supply of the second crypto token.

In some examples of the method, apparatuses, and non-transitory computer-readable medium described herein, associating the second amount with the first user profile may include operations, features, means, or instructions for retrieving the second amount of the second crypto token from a token pool managed by the custodial token platform, wherein the token pool includes a supply of the second crypto token that may be minted by the self-executing program deployed to the blockchain network.

Some examples of the method, apparatuses, and non-transitory computer-readable medium described herein may further include operations, features, means, or instructions for broadcasting a first message that may be configured to delegate the first amount of the first crypto token to a staking self-executing program associated with the custodial token platform and broadcasting, after confirmation of the first message via the blockchain network and before receiving the first request, a second message that may be configured to cause the self-executing program to mint the second amount of the second crypto token and attribute the second amount to an address associated with the custodial token platform.

Some examples of the method, apparatuses, and non-transitory computer-readable medium described herein may further include operations, features, means, or instructions for receiving, at the custodial token platform, a staking request to stake the first amount of the first crypto token via the custodial token platform, wherein the first message may be broadcast based at least in part on receiving the staking request, activating, after receiving the staking request and prior to confirmation of the first message, staking returns associated with the first user profile for the first amount of the first crypto token, and activating, after receiving the staking request and prior to confirmation of the first message, access to a service for wrapping the first amount of the first crypto token.

In some examples of the method, apparatuses, and non-transitory computer-readable medium described herein, the first amount of the first crypto token may be locked for staking for a time period after receiving the staking request.

Some examples of the method, apparatuses, and non-transitory computer-readable medium described herein may further include operations, features, means, or instructions for determining the first value or the second value of the current conversion ratio based least in part on a ratio between a total supply of the first crypto token that may be staked in accordance with the protocol and a total supply of the second crypto token that may be minted by the self-executing program.

In some examples of the method, apparatuses, and non-transitory computer-readable medium described herein, the total supply of the first crypto token includes a staking return for staking the first crypto token in accordance with the protocol, a slashing penalty associated with staking the first crypto token in accordance with the protocol, or both.

Some examples of the method, apparatuses, and non-transitory computer-readable medium described herein may further include operations, features, means, or instructions for broadcasting, after associating the second amount of the second crypto token with the first user profile, a message that may be configured to transfer one or more of the second crypto token from the first user profile of the custodial token platform to an address that may be external to the custodial token platform, wherein the first user profile may be subject to staking returns associated with the first crypto token after broadcasting the message.

It should be noted that the methods described above describe possible implementations, and that the operations and the steps may be rearranged or otherwise modified and that other implementations are possible. Furthermore, aspects from two or more of the methods may be combined.

The description set forth herein, in connection with the appended drawings, describes example configurations and does not represent all the examples that may be implemented or that are within the scope of the claims. The term “exemplary” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, well-known structures and devices are shown in block diagram form in order to avoid obscuring the concepts of the described examples.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label.

Information and signals described herein may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative blocks and modules described in connection with the disclosure herein may be implemented or performed with a general-purpose processor, a DSP, an ASIC, an FPGA or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described above can be implemented using software executed by a processor, hardware, firmware, hardwiring, or combinations of any of these. Features implementing functions may also be physically located at various positions, including being distributed such that portions of functions are implemented at different physical locations. Further, a system as used herein may be a collection of devices, a single device, or aspects within a single device.

Also, as used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

Computer-readable media includes both non-transitory computer storage media and communication media including any medium that facilitates transfer of a computer program from one place to another. A non-transitory storage medium may be any available medium that can be accessed by a general purpose or special purpose computer. By way of example, and not limitation, non-transitory computer-readable media can comprise RAM, ROM, EEPROM) compact disk (CD) ROM or other optical disk storage, magnetic disk storage or other magnetic storage devices, or any other non-transitory medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

The description herein is provided to enable a person skilled in the art to make or use the disclosure. Various modifications to the disclosure will be readily apparent to those skilled in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A method for data processing, comprising:
receiving, at a custodial token platform from a first user profile, a first request to wrap a first amount of a first crypto token that is staked in accordance with a protocol associated with a blockchain network supported distributed data store:
associating, after receiving the first request, a second amount of a second crypto token with the first user profile, the second crypto token being transferrable via the protocol associated with the blockchain network supported distributed data store and being minted by a self-executing program deployed to the blockchain network supported distributed data store, the second amount being based on a first value of a current conversion ratio between the first crypto token and the second crypto token:
receiving, at the custodial token platform from a second user profile, a second request to unwrap the second crypto token; and
associating, after receiving the second request, the second user profile with a third amount of the first crypto token, the third amount being based on a second value of the current conversion ratio between the first crypto token and the second crypto token.

2. The method of claim 1, further comprising:
broadcasting, to the blockchain network, a message that is configured to cause the self-executing program to mint a total supply of the second crypto token that is equal to a total supply of the first crypto token staked via the custodial token platform, wherein the second amount is retrieved from one or more token pools managed by the custodial token platform that are attributed with the total supply of the second crypto token.

3. The method of claim 1, wherein associating the second amount with the first user profile comprises:
retrieving the second amount of the second crypto token from a token pool managed by the custodial token platform, wherein the token pool includes a supply of the second crypto token that is minted by the self-executing program deployed to the blockchain network.

4. The method of claim 1, further comprising:
broadcasting a first message that is configured to delegate the first amount of the first crypto token to a staking self-executing program associated with the custodial token platform; and
broadcasting, after confirmation of the first message via the blockchain network and before receiving the first request, a second message that is configured to cause the self-executing program to mint the second amount of the second crypto token and attribute the second amount to an address associated with the custodial token platform.

5. The method of claim 4, further comprising:
receiving, at the custodial token platform, a staking request to stake the first amount of the first crypto token via the custodial token platform, wherein the first message is broadcast based at least in part on receiving the staking request:
activating, after receiving the staking request and prior to confirmation of the first message, staking returns associated with the first user profile for the first amount of the first crypto token; and
activating, after receiving the staking request and prior to confirmation of the first message, access to a service for wrapping the first amount of the first crypto token.

6. The method of claim 5, wherein the first amount of the first crypto token is locked for staking for a time period after receiving the staking request.

7. The method of claim 1, further comprising:
determining the first value or the second value of the current conversion ratio based least in part on a ratio between a total supply of the first crypto token that is staked in accordance with the protocol and a total supply of the second crypto token that is minted by the self-executing program.

8. The method of claim 7, wherein the total supply of the first crypto token includes a staking return for staking the first crypto token in accordance with the protocol, a slashing penalty associated with staking the first crypto token in accordance with the protocol, or both.

9. The method of claim 1, further comprising:
broadcasting, after associating the second amount of the second crypto token with the first user profile, a message that is configured to transfer one or more of the second crypto token from the first user profile of the custodial token platform to an address that is external to the custodial token platform, wherein the first user profile is subject to staking returns associated with the first crypto token after broadcasting the message.

10. An apparatus for data processing, comprising:
a processor:
memory coupled with the processor; and
instructions stored in the memory and executable by the processor to cause the apparatus to:
receive, at a custodial token platform from a first user profile, a first request to wrap a first amount of a first crypto token that is staked in accordance with a protocol associated with a blockchain network supported distributed data store:
associate, after receiving the first request, a second amount of a second crypto token with the first user profile, the second crypto token being transferrable via the protocol associated with the blockchain network supported distributed data store and being minted by a self-executing program deployed to the blockchain network supported distributed data store, the second amount being based on a first value of a current conversion ratio between the first crypto token and the second crypto token:
receive, at the custodial token platform from a second user profile, a second request to unwrap the second crypto token; and
associate, after receiving the second request, the second user profile with a third amount of the first crypto token, the third amount being based on a second value of the current conversion ratio between the first crypto token and the second crypto token.

11. The apparatus of claim 10, wherein the instructions are further executable by the processor to cause the apparatus to:
broadcast, to the blockchain network, a message that is configured to cause the self-executing program to mint a total supply of the second crypto token that is equal to a total supply of the first crypto token staked via the custodial token platform, wherein the second amount is retrieved from one or more token pools managed by the custodial token platform that are attributed with the total supply of the second crypto token.

12. The apparatus of claim 10, wherein the instructions to associate the second amount with the first user profile are executable by the processor to cause the apparatus to:
retrieve the second amount of the second crypto token from a token pool managed by the custodial token platform, wherein the token pool includes a supply of the second crypto token that is minted by the self-executing program deployed to the blockchain network.

13. The apparatus of claim 10, wherein the instructions are further executable by the processor to cause the apparatus to:
broadcast a first message that is configured to delegate the first amount of the first crypto token to a staking self-executing program associated with the custodial token platform; and
broadcast, after confirmation of the first message via the blockchain network and before receiving the first request, a second message that is configured to cause the self-executing program to mint the second amount of the second crypto token and attribute the second amount to an address associated with the custodial token platform.

14. The apparatus of claim 13, wherein the instructions are further executable by the processor to cause the apparatus to:
receive, at the custodial token platform, a staking request to stake the first amount of the first crypto token via the custodial token platform, wherein the first message is broadcast based at least in part on receiving the staking request:
activate, after receiving the staking request and prior to confirmation of the first message, staking returns associated with the first user profile for the first amount of the first crypto token; and
activate, after receiving the staking request and prior to confirmation of the first message, access to a service for wrapping the first amount of the first crypto token.

15. The apparatus of claim 14, wherein the first amount of the first crypto token is locked for staking for a time period after receiving the staking request.

16. The apparatus of claim 10, wherein the instructions are further executable by the processor to cause the apparatus to:
determine the first value or the second value of the current conversion ratio based least in part on a ratio between a total supply of the first crypto token that is staked in accordance with the protocol and a total supply of the second crypto token that is minted by the self-executing program.

17. The apparatus of claim 16, wherein the total supply of the first crypto token includes a staking return for staking the first crypto token in accordance with the protocol, a slashing penalty associated with staking the first crypto token in accordance with the protocol, or both.

18. The apparatus of claim 10, wherein the instructions are further executable by the processor to cause the apparatus to:
broadcast, after associating the second amount of the second crypto token with the first user profile, a message that is configured to transfer one or more of the second crypto token from the first user profile of the custodial token platform to an address that is external to the custodial token platform, wherein the first user profile is subject to staking returns associated with the first crypto token after broadcasting the message.

19. A non-transitory computer-readable medium storing code for data processing, the code comprising instructions executable by a processor to:
receive, at a custodial token platform from a first user profile, a first request to wrap a first amount of a first crypto token that is staked in accordance with a protocol associated with a blockchain network supported distributed data store:
associate, after receiving the first request, a second amount of a second crypto token with the first user profile, the second crypto token being transferrable via the protocol associated with the blockchain network supported distributed data store and being minted by a self-executing program deployed to the blockchain network supported distributed data store, the second amount being based on a first value of a current conversion ratio between the first crypto token and the second crypto token:
receive, at the custodial token platform from a second user profile, a second request to unwrap the second crypto token; and
associate, after receiving the second request, the second user profile with a third amount of the first crypto token, the third amount being based on a second value of the current conversion ratio between the first crypto token and the second crypto token.

20. The non-transitory computer-readable medium of claim 19, wherein the instructions are further executable by the processor to:
broadcast, to the blockchain network, a message that is configured to cause the self-executing program to mint a total supply of the second crypto token that is equal to a total supply of the first crypto token staked via the custodial token platform, wherein the second amount is retrieved from one or more token pools managed by the custodial token platform that are attributed with the total supply of the second crypto token.
